(19) United States
(12) Patent Application Publication
(10) Pub. No.: US 2025/0278701 A1
(43) Pub. Date: Sep. 4, 2025

(54) Methods And Computing Systems For Scheduling Vehicle Maintenance

(71) Applicant: Ansik Inc., Toronto (CA)

(72) Inventors: Christopher D. Mah, North York (CA); Shyam Krishnan Gopikrishnan, Toronto (CA); Shiva Bhardwaj, Toronto (CA)

(21) Appl. No.: 18/821,227

(22) Filed: Aug. 30, 2024

Related U.S. Application Data
(60) Provisional application No. 63/559,520, filed on Feb. 29, 2024.

(51) Int. Cl. G06Q 10/20

(52) U.S. Cl. CPC G06Q 10/20

(57) ABSTRACT

Systems and methods for scheduling vehicle maintenance and improving fleet management. A fault code history and a service event history for a set of vehicles is received, the fault code history including fault code events for each of a set of fault codes, the service event history including service events for each of a set of service event types. Subsets of the fault codes are correlated with subsets of the service events at least partially based on histories. A service priority rating is assigned to each fault code of the set of fault codes at least partially based on the correlated subset or subsets of the service events, the fault code history, and the service event history. A vehicle maintenance event schedule is scheduled for a vehicle based on the service priority rating for each fault code event for the vehicle.

### CROSS-REFERENCE TO RELATED APPLICATIONS

The present application claims priority from U.S. Provisional application Ser. No. 63/559,520, filed on Feb. 29, 2024.

### TECHNICAL FIELD

The present disclosure relates to vehicle maintenance, and, in particular, to methods and computing systems for scheduling vehicle maintenance.

### BACKGROUND

Modern vehicles are complex machines, which can be subject to a large number of failure modes that are difficult to diagnose or predict. Wear of internal parts, improper lubrication or loading, corrosion, failure of electrical control systems, and failure to renew consumable elements may each lead to the vehicle systems operating abnormally. These conditions then lead to expensive repairs, or make the vehicle unsafe, or simply cause downtime and delay.

To simplify diagnosis and repair, vehicle manufacturers have enabled sensors within the vehicle to detect and signal many error conditions. These signals are known as fault codes. Two systems are in general use, including OBD-II codes for light vehicles, and J1939 for heavy vehicles. As is known to those skilled in the art of vehicle maintenance, when a significant fault code is received or observed, a vehicle may be brought to a shop for more detailed examination and diagnosis on an ad hoc basis.

Decisions about necessary repairs are then made taking into account the usage of the vehicle, its overall condition and the needs of the end user. The decision to bring a vehicle to the shop if a fault code is seen is not always straightforward and can involve a number of considerations.

In contrast, manufacturers recommend periodic maintenance (PM) at intervals based on time, mileage, or engine hours to replenish fluids, replace consumable parts such as filters, and to clean, adjust or replace other parts such as hoses, brake pads, spark plugs, batteries and other components which can degrade during the normal lifetime of the vehicle.

In this case, the decision to bring the vehicle to the shop is simple, because it happens when thresholds for time, mileage or engine hours are approached. However, when periodic maintenance, and fault code based shop visits decisions are made independent of one another, this may result in serious conditions which go undetected until a breakdown actually occurs or, alternatively, unnecessary shop visits. Neglected conditions may result in repeat visits due to related causes. Breakdowns and downtime also incur costs such as driver salary which are extra to the cost of maintaining the vehicle.

Therefore, there is a need to organize and manage decision making for shop visits which can be scheduled, which remedy or mitigate known error conditions in the vehicle before they become emergencies. Savings can be achieved if this is done in an appropriate and efficient way. It is not effective to immediately schedule a shop visit for any and all fault code-signaled error conditions which may be observed, such as misfires. However, it may be calculated that some level of breakdown risk justifies visiting a shop very soon.

### SUMMARY

The present disclosure describes systems and methods which provide one or more efficient techniques to perform vehicle maintenance scheduling.

In accordance with a first aspect of the present disclosure, there is provided a computer-implemented method for scheduling vehicle maintenance, comprising: receiving a fault code history and a service event history for a set of vehicles, the fault code history including fault code events for each of a set of fault codes, the service event history including service events for each of a set of service event types; correlating subsets of the set of fault codes with subsets of the service events at least partially based on the fault code history and the service event history; assigning a service priority rating to each fault code of the set of fault codes at least partially based on the correlated subset or subsets of the service events, the fault code history, and the service event history; and scheduling a vehicle maintenance event for a vehicle based on the service priority rating for each fault code event for the vehicle.

In some exemplary embodiments of the first aspect, the subsets of the set of fault codes include two or more fault codes of the set of fault codes.

In some exemplary embodiments of the first aspect, the method can include: estimating at least one of service availability and part availability for at least some of the set of the service event types, and the assigning of the service priority rating is at least partially based on the at least one of the estimated service availability and the estimated part availability for the at least some of the set for the service type events.

In some exemplary embodiments of the first aspect, the fault code history is a first fault code history for a first set of vehicles of a first vehicle type, the service event history is a first service event history for the first set of vehicles, the service priority rating is a first service priority rating, and the method further includes: receiving a second fault code history and a second service event history for a second set of vehicles, the second fault code history including fault code events for each of the set of fault codes, the second service event history including service events for each of a set of service event types; correlating subsets of the set of fault codes with subsets of the service events at least partially based on the second fault code history and the second service event history; and assigning a second service priority rating to each fault code of the set of fault codes at least partially based on the correlated subset or subsets of the service events, the second fault code history, and the second service event history, wherein the revising includes revising the vehicle maintenance event schedule for the vehicle based on the first service priority rating for each fault code event for the vehicle if the vehicle is of the first vehicle type, or based on the second service priority rating for each fault code event for the vehicle if the vehicle is of the second vehicle type.

In some exemplary embodiments of the first aspect, the correlating includes determining a mean time to failure for each subset of fault codes.

In some exemplary embodiments of the first aspect, the correlating includes determining a mean time to failure for each fault code of the set of fault codes.

In some exemplary embodiments of the first aspect, the service priority rating is at least partially based on downtime cost.

In some exemplary embodiments of the first aspect, the service priority rating is at least partially based on an estimated time to failure.

In some exemplary embodiments of the first aspect, the assigning includes, for each of the set of fault codes, a total number of positive cases where fault code events led to service events and a total number of negative cases where an absence of fault code events led to an absence of service events.

In some exemplary embodiments of the first aspect, the correlating is performed using a machine learning model.

In a second aspect of the present disclosure, there is provided a computing system for scheduling vehicle maintenance, comprising: one or more processors; and a memory storing machine-executable instructions that, when executed by the one or more processors, cause the computing system to: receive a fault code history and a service event history for a set of vehicles, the fault code history including fault code events for each of a set of fault codes, the service event history including service events for each of a set of service event types; correlate subsets of the set of fault codes with subsets of the service events at least partially based on the fault code history and the service event history; assign a service priority rating to each fault code of the set of fault codes at least partially based on the correlated subset or subsets of the service events, the fault code history, and the service event history; and schedule a vehicle maintenance event for a vehicle based on the service priority rating for each fault code event for the vehicle.

In some exemplary embodiments of the second aspect, the subsets of the set of fault codes include two or more fault codes of the set of fault codes.

In some exemplary embodiments of the second aspect, the machine-executable instructions, when executed by the one or more processors, cause the computing system to: estimate at least one of service availability and part availability for at least some of the set of the service event types, and assign the service priority rating at least partially based on the at least one of the estimated service availability and the estimated part availability for the at least some of the set for the service type events.

In some exemplary embodiments of the second aspect, the fault code history is a first fault code history for a first set of vehicles of a first vehicle type, the service event history is a first service event history for the first set of vehicles, the service priority rating is a first service priority rating, and wherein the machine-executable instructions, when executed by the one or more processors, cause the computing system to: receive a second fault code history and a second service event history for a second set of vehicles, the second fault code history including fault code events for each of the set of fault codes, the second service event history including service events for each of a set of service event types; correlate subsets of the set of fault codes with subsets of the service events at least partially based on the second fault code history and the second service event history; assign a second service priority rating to each fault code of the set of fault codes at least partially based on the correlated subset or subsets of the service events, the second fault code history, and the second service event history; and revise the vehicle maintenance event schedule for the vehicle based on the first service priority rating for each fault code event for the vehicle if the vehicle is of the first vehicle type, or based on the second service priority rating for each fault code event for the vehicle if the vehicle is of the second vehicle type.

In some exemplary embodiments of the second aspect, the machine-executable instructions, when executed by the one or more processors, cause the computing system to determine a mean time to failure for each subset of fault codes.

In some exemplary embodiments of the second aspect, the machine-executable instructions, when executed by the one or more processors, cause the computing system to determine a mean time to failure for each fault code of the set of fault codes.

In some exemplary embodiments of the second aspect, the machine-executable instructions, when executed by the one or more processors, cause the computing system to determine the service priority rating at least partially based on downtime cost.

In some exemplary embodiments of the second aspect, the service priority rating is at least partially based on an estimated time to failure.

In some exemplary embodiments of the second aspect, the machine-executable instructions, when executed by the one or more processors, cause the computing system to assign, for each of the set of fault codes, a total number of positive cases where fault code events led to service events and a total number of negative cases where an absence of fault code events led to an absence of service events.

In some exemplary embodiments of the second aspect, the machine-executable instructions, when executed by the one or more processors, cause the computing system to correlate the subsets of the set of fault codes with subsets of the service events using a machine learning model.

In a third aspect of the present disclosure, there is provided a non-transitory machine-readable medium having tangibly stored thereon executable instructions for execution by one or more processors, wherein the executable instructions, in response to execution by the one or more processors, cause the one or more processors to perform any one of the methods described above.

Other aspects and features of the present disclosure will become apparent to those of ordinary skill in the art upon review of the following description of specific implementations of the application in conjunction with the accompanying figures.

### BRIEF DESCRIPTION OF THE DRAWINGS

Reference will now be made, by way of example, to the accompanying drawings which show example embodiments of the present application, and in which:

FIG. 1 is a schematic diagram illustrating a computing system for scheduling vehicle maintenance and its operating environment in accordance with example embodiments described herein.

FIG. 2 is a flow chart of a general method of scheduling vehicle maintenance in accordance with example embodiments described herein.

FIG. 3 illustrates three different scenarios of relationships between fault codes and service events.

FIG. 4 illustrates three different scenarios of relationships between fault codes and service events.

FIG. 5 is a flow chart of a general method of scheduling vehicle maintenance in accordance with example embodiments described herein.

FIG. 6 is a schematic diagram of an exemplary exhaust system of a vehicle for which fault codes may be generated.

FIG. 7 is a graph of cluster center coordinates with min inertia.

FIG. 8 is a schematic diagram illustrating various components of a computing system for scheduling vehicle maintenance in accordance with some example embodiments described herein.

Similar reference numerals may have been used in different figures to denote similar components. Unless otherwise specifically noted, articles depicted in the drawings are not necessarily drawn to scale.

### DETAILED DESCRIPTION OF EXAMPLE EMBODIMENTS

The present disclosure is made with reference to the accompanying drawings, in which embodiments are shown. However, many different embodiments may be used, and thus the description should not be construed as limited to the embodiments set forth herein. Rather, these embodiments are provided so that this application will be thorough and complete. Wherever possible, the same reference numbers are used in the drawings and the following description to refer to the same elements, and prime notation is used to indicate similar elements, operations or steps in alternative embodiments. Separate boxes or illustrated separation of functional elements of illustrated systems and devices does not necessarily require physical separation of such functions, as communication between such elements may occur by way of messaging, function calls, shared memory space, and so on, without any such physical separation. As such, functions need not be implemented in physically or logically separated platforms, although such functions are illustrated separately for ease of explanation herein. Different devices may have different designs, such that although some devices implement some functions in fixed function hardware, other devices may implement such functions in a programmable processor with code obtained from a machine-readable medium. Lastly, elements referred to in the singular may be plural and vice versa, except where indicated otherwise either explicitly or inherently by context.

The present disclosure describes methods and computing systems for scheduling vehicle maintenance from priorities determined for fault code events. For example, it may be desirable to address some fault code events more immediately based on their correlation to failures/downtime, and other fault code events less immediately, such as at the next scheduled periodic maintenance. It also describes methods to more quickly and accurately determine a course of action by combining fault codes to get to accurate diagnoses. These methods apply to larger fleets of similar vehicles as well as classes of similar vehicle which might not be managed as single fleets.

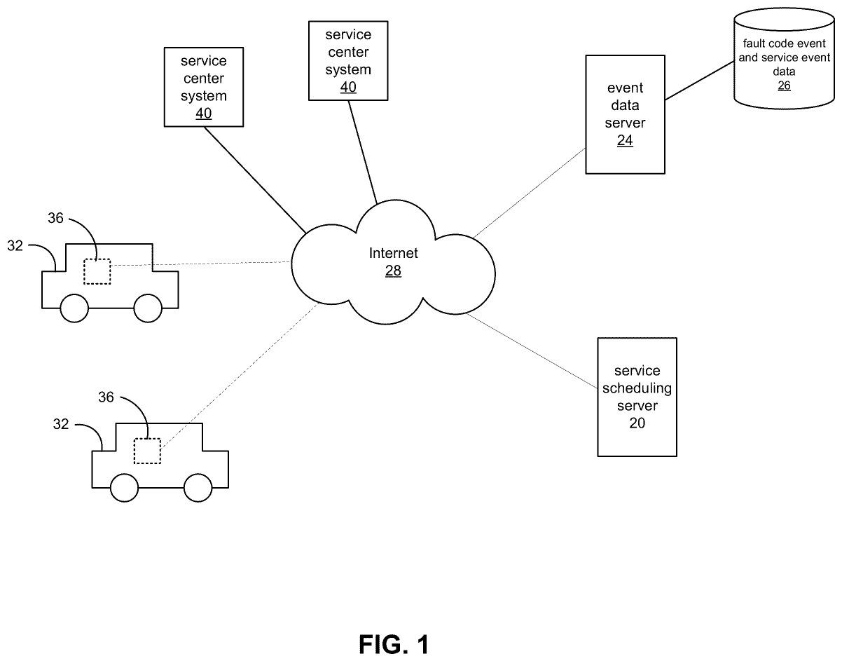

FIG. 1 shows a service scheduling server 20 for scheduling vehicle maintenance in accordance with example embodiments described herein. The service scheduling server 20 is a computing system that is in communication with an event data server 24 over a data communications network such as the Internet 28 or any other type of suitable data communications network. The event data server 24 maintains a database 26 of fault code events and service events for a fleet of vehicles 32.

Each vehicle 32 has a control unit 36 that receives fault code events from various electronic components and sensors of the vehicle 32 and communicates these fault code events to the event data server 24 via any suitable wired or wireless communications means. The fault code events include the particular fault code(s). In some example embodiments, each of the control units 36 includes a wireless communications module for communicating with the event data server 24 over the Internet 28.

In addition, the event data server 24 is in communication with one or more service center systems 40 for receiving service event data. The service event data includes a set of records, each specifying a vehicle (and optionally a vehicle type), a service event (such as the type of service provided to the vehicle), and a date.

While the event data server 24 and the service scheduling server 20 are shown as separate devices in FIG. 1, it will be appreciated that the service scheduling server 20 can assume all of the functionality of the event data server 24, including the maintenance of the database 26.

The fault code event data and the service event data is stored in the database 26 in any suitable format and structure so that the fault code events and service events can be retrieved and correlated.

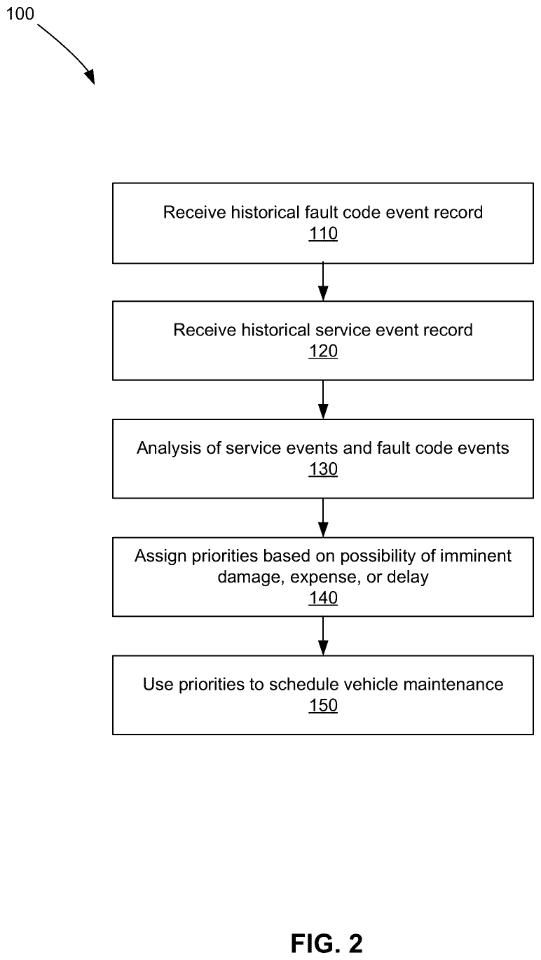

FIG. 2 is a flow chart of a general method 100 of scheduling vehicle maintenance in accordance with example embodiments described herein. In the method 100, fault code events and service events are correlated to determine a rating for each fault code. These ratings are then used to manage the scheduling of service events for the vehicles 32.

The method 100 commences with the receipt of a historical fault code event record for the fleet of vehicles 32 (110). The fault code event record includes data for a set of fault code events, including a vehicle identifier, a fault code, a date and time, and can include other data, such as the mileage of the vehicle at the time of the fault code event. A historical service event record is also received (120). The historical service event record includes data for a set of service events, including a vehicle identifier, a service type, and a date and time of the service event. The service type can include a service performed, such as the replacement of one or more parts, an oil change, wheel balancing, etc. The fault code event record and the service event record can be retrieved from existing data sets or can be collected during use of the system including the service scheduling server 20.

The fault code events and the service events are then analyzed (130). The fault code events and the service events are segregated for each vehicle so that the fault code events and the service events are grouped by vehicle. The fault code events are analyzed over a period of time and the underlying frequencies of the fault codes are observed.

In some embodiments, the analysis is performed separately for each vehicle type. Vehicle types can correspond to vehicles from different manufacturers, different vehicle models from the manufacturers, and even different years of manufacture.

The mean times to failure or repair in the service record are then tabulated for each fault code.

In some embodiments, the analysis performed at 130 can include tabulating the frequency of a related service event, such as a repair, by fault code event (i.e., occurrence of a fault code) in a designated period such as 14 days, where the 14-day period before a known repair is tabulated across many vehicle examples.

Priorities are then assigned based on the possibility of imminent damage, expense, or delay (140). In this analysis, a fault code which occurs more frequently before the target repair and less frequently in a random 14-day window may receive a higher priority.

These priorities are then used to schedule vehicle maintenance (150). Vehicle maintenance can include repairs, servicing, part replacement, fluid replacement or replenishing, etc.

The fault code event record can be received directly from the vehicles over time, received from another system that aggregates this information, etc. The service event record can be received from one or more service providers, or collected in any other suitable approach.

The fault code events and service events are analyzed to understand the relationships between them, given the data received.

In some embodiments, a contingency table may be formed over a single time window for a pool of vehicles and fault code priority may be assessed using a combination of accuracy and repair expense. In this analysis, accuracy is assessed using measures such as (TP+TN)/N where true positives (TP) is the number of cases in which a fault code was observed before a repair, true negatives (TN) is the number of cases where there was no repair and no fault code within the time window, while N is the total number of cases.

Specific costs for false positives (FP) and false negatives (FN) may be assigned, and costs and savings may be combined to perform an overall optimization, when assigning priority at 140.

Given that fault codes can sometimes trigger repeatedly, the analysis of the service events and the fault code events may be performed using a machine learning algorithm to predict the occurrence of a repair based on the specific fault code and the frequency and time-based pattern of triggering, and thus determine a priority for the fault code(s).

In other embodiments, the collation with service records may be replaced with a deductive process based on known pathology when several related fault codes (a cluster) occur close together in time for a vehicle.

It will also be clear to those skilled in the art that the term root causes may be understood in a mechanical or in a statistical sense, since the precise mechanisms of failure modes may not be accessible in telematics data.

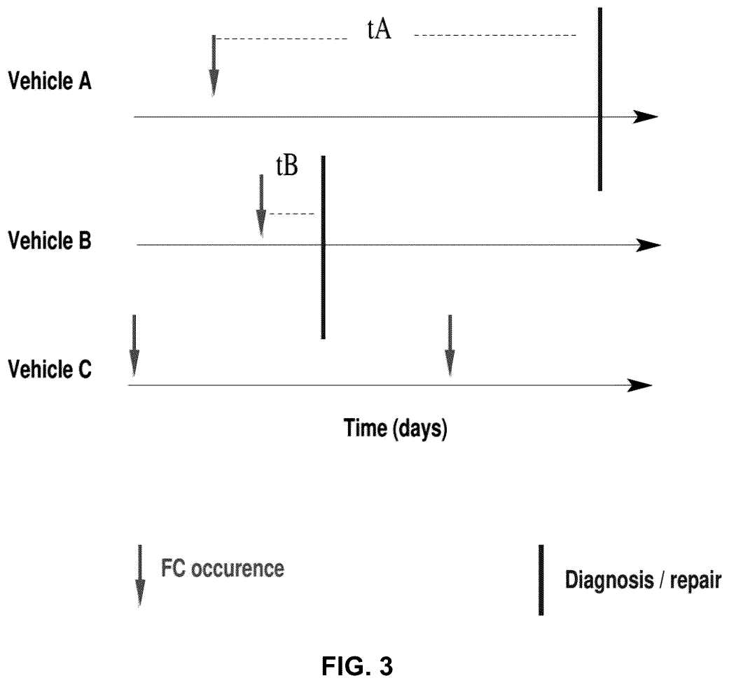

FIG. 3 shows different cases of relative fault code timings within a fleet. Different fault codes will have different characteristic timings. For example, some fault codes such as misfire codes may occur often, but may not often lead to quick breakdown (i.e., case C vs case B). Others, such as derate codes (case B) may usually lead to a shop visit within a short period of time because they make the vehicle unusable. Specific information about these timings can be useful because it represents a data-driven summary of the importance of that code. This analysis would be done for each code which has occurred at least once fleetwide.

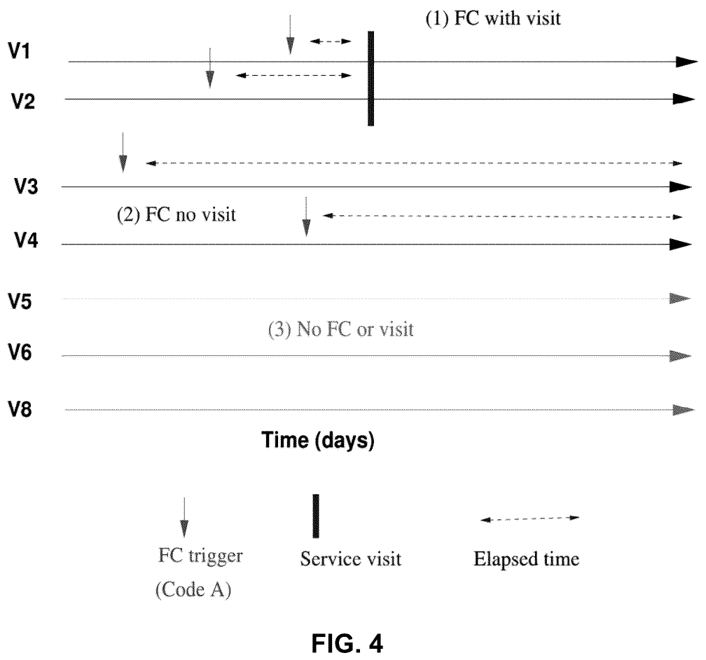

FIG. 4 is a diagram of the relative timing of fault codes and related service events for vehicles within a hypothetical fleet for a single fault code. In this case, N=2 for group 1, N=2 for group 2 and N=3 for group 3. Of the vehicles showing fault code A, group 1 exhibits fault code events with an estimate of the time lag between fault code and service event. Group 2 exhibits fault code events with no service events extending to the end of the observation window, which is a lower bound for those true elapsed times. Since group 2 (no shop visit) times will be greater than or equal to group 1 (shop visit) times, a larger number of group 2 cases will imply a larger mean time to service visit.

Some fault codes may trigger repeatedly in response to the same error condition. This can disrupt the time estimates since we will not know which fault code trigger time to use. Typically, there will not be enough data to make an accurate model of repeat triggers, so the number of vehicles that had each code is received and the times for repeated triggers are averaged within that vehicle.

This picture shows how to translate counts of fault code incidence in a fleet and elapsed times from fault code events to service events into a lower bound for the expected time to service event (failure). To calculate this, the elapsed times in FIG. 4 from group 1 and group 2 are averaged.

A fault code that occurs often and only sometimes occurs before a service visit is less predictive than a fault code which occurs rarely and always results in a service visit. The calculation proposed above results in a single number which is interpretable as the mean estimated time to service (mETTS).

Shorter times to failure reflect few code occurrences with no visit versus many occurrences which are soon followed by a visit. The estimated time is a statistical estimate, but it represents a typical experience for a specific fault code. Therefore it can be useful for code prioritization.

For example, if two codes have equal severity, but one of the fault codes has a significant shorter expected time to service, it should receive attention sooner, since it is more likely to fail sooner.

If no shop visit is seen within the observation period after a fault code, this does not necessarily mean the code was spurious or worthless for prediction. Instead, it may mean that the observation period was too short. However, as the length of the observation period increases, convergence toward a true estimate may be expected. The values obtained in any reasonable observation window remain useful.

These principles were applied to construct the mETTS metric.

To do this, the fleet was split into the sets of vehicles. The first set CEL had check engine light associated visits in their service records, comprising 57 unique visits (one vehicle, one date), and 33 vehicles between Dec. 5, 2022 and Apr. 2, 2023. Any codes (29) which had occurred in the five-day period before a ‘check engine light’ service event were then tabulated. This list will be called LB5cel and is given in Table 1 and Table 2 below.

TABLE 1
Dtc codes in 5 days before check engine light (LB5cel)

| Code | Description |
|---|---|
| P0420 | Catalyst system efficiency below threshold bank 1 |
| P0457 | EVAP system leak detected (fuel cap loose/off) |
| P0353 | Ignition coil C primary control |
| P0455 | EVAP system leak detected - large leak |
| P06B6 | Internal control module knock/combustion vibration sensor |
| | processor 1 performance |
| U0108 | Lost Communication With Alternative Fuel Control Module |
| P0191 | Fuel rail pressure sensor circuit range/performance bank 1 |
| P0305 | Cylinder 5 misfire detected |
| P0124 | Throttle/Pedal Position Sensor/Switch ‘A’ Circuit Intermittent |
| P0300 | Random misfire detected |
| P0401 | EGR A flow insufficient detected |
| P0456 | EVAP system leak detected (very small leak) |
| P0304 | Cylinder 4 misfire detected |

TABLE 2
SPN codes in 5 days before check engine light (LB5cel)

| Code | Description |
|---|---|
| 91 | Accelerator pedal position 1 |
| 8289 | Fuel system control module |
| 3359 | Transmission oil filter restriction switch |
| 524286 | Automatic Gear Selection - Incompatible or missing dataset |
| 1390 | Engine fuel valve 1 intake absolute pressure |
| 810 | Speed signal input |
| 627 | Power supply (obsolete) |
| 1327 | Engine cylinder 5 misfire rate |
| 1180 | Engine Turbocharger 1 Turbine Intake Temperature |
| 411 | Engine exhaust gas recirculation 1 differential pressure |
| 111 | Coolant level |
| 2003 | Source address 3 |
| 84 | Wheel-Based Vehicle Speed |
| 2659 | Engine exhaust gas recirculation 1 mass flow rate |
| 1322 | Engine misfire for multiple cylinders |
| 168 | Battery potential (voltage) |

The second set of vehicles (NO CEL) had no check engine light visits during this time period. This consisted of 648 vehicles, for which 130 vehicles had codes from LB5cel at some time in the telematics record.

Where there is more than one vehicle type, the vehicle type can also be retrieved.

The fault codes which occur before significant related repairs receive a priority based on the expense or downtime consequence of the repair, the likelihood that a repair is seen in the record when the fault code is seen, and how quickly a failure might occur. fault codes which occur closer in time to a repair, or signal more expensive repairs in time or money receive a higher priority.

When counting, it is important to remember that any vehicle could show more than one code (e.g., P0300 and P0420) during the observation period. In addition, any single code might occur repeatedly, triggering at different times.

Since it is desired to count underlying failure modes, the main count associated with each code was the number of vehicles which had exhibited that code at least once during the three months. Specifically, a single code triggering would signal a failure mode, but the conditions for repeated triggering might be more related to how the system was programmed to signal. Therefore, when computing the mean time to service mETTS for an individual vehicle (longitudinally), the calculation took each trigger time for that code on that vehicle and averaged all the times to end-of-record or time-of-service (check engine light).

The remaining NO CEL vehicles did not have shop visits for check engine light. Those vehicles had code incidences as shown in Tables 5 and 6. As might be expected from a set of vehicles which did not have check engine light service, some codes such as fault code P0353, SPN 1180 were not observed at all; i.e., count=0. On the other hand, most vehicle counts were larger than in the CEL group, reflecting the size (130) of the underlying pool of vehicles. Totals do not add since vehicles could have multiple codes.

Tables 6 to 9 below show counts for the above fault codes separated into the 2 vehicle subsets CEL and NO CEL.

Finally, the estimates from CEL and NO CEL groups were combined by fault code, weighted by incidence and ranked by mETTS, as shown in Tables 3 and 4.

The mETTS should not be directly interpreted as a safe waiting period. It is not a safe waiting period. This estimate is subject to sampling errors in this relatively short observation period.

However, when shop resources are limited, this ranking of fault codes, ascending on mETTS should provide a reasonable way to decide which vehicles need attention sooner than the others.

Alternatively mETTS can be treated like a ‘best before’ date associated with the failure mode signaled by that fault code, where this estimate is supported by evidence.

It would also be reasonable to escalate priorities for these codes after they have been present for their mETTS elapsed times, or some fraction of it.

TABLE 3
LB5cel Fault codes ranked by expected time to service

| | mETTS | |
|---|---|---|
| Code | (days) | Description |
| P0353 | 2.8 | Ignition coil C primary control |
| P0191 | 4.1 | Fuel rail pressure sensor circuit range/performance |
| | | bank 1 |
| P0124 | 8.8 | Throttle/Pedal Position Sensor/Switch ‘A’ Circuit |
| | | Intermittent |
| P06B6 | 13.5 | Internal control module knock/combustion vibration |
| | | sensor processor 1 performance |
| U0108 | 14.7 | Lost Communication With Alternative Fuel Control |
| | | Module |
| P0457 | 35.1 | Catalyst system efficiency below threshold bank 1 |
| P0456 | 42.1 | EVAP system leak detected (very small leak) |
| P0401 | 46.7 | EGR A flow insufficient detected |
| P0455 | 50.7 | EVAP system leak detected - large leak |
| P0304 | 50.8 | Cylinder 4 misfire detected |
| P0300 | 59.2 | Random misfire detected |
| P0420 | 66 | Catalyst system efficiency below threshold bank 1 |
| P0305 | 71 | Cylinder 5 misfire detected |

TABLE 4
LB5cel SPN codes ranked by expected time to service

| | mETTS | |
|---|---|---|
| Code | (days) | Description |
| 1180 | 3.6 | Engine Turbocharger 1 Turbine Intake Temperature |
| 2659 | 37.5 | Engine exhaust gas recirculation 1 mass flow rate |
| 168 | 46.5 | Battery potential (voltage) |
| 111 | 48.1 | Coolant level |
| 1327 | 49.6 | Engine cylinder 5 misfire rate |
| 1322 | 50.1 | Engine misfire for multiple cylinders |
| 810 | 53.2 | Speed signal input |
| 84 | 55 | Wheel-Based Vehicle Speed |
| 524286 | 57.1 | Automatic Gear Selection - Incompatible or missing |
| | | dataset |
| 91 | 59.3 | Accelerator pedal position 1 |
| 2003 | 59.5 | Source address 3 |
| 411 | 61 | Engine exhaust gas recirculation 1 differential pressure |
| 627 | 60.1 | Power supply (obsolete) |
| 3359 | 64.8 | Transmission oil filter restriction switch |
| 1390 | 68.1 | Engine fuel valve 1 intake absolute pressure |
| 8289 | 68.3 | Fuel system control module |

It may happen when scheduling vehicle maintenance as disclosed herein, that the service records are incomplete, or do not have enough detail. It is also common that different fleet keep records with different diagnostic categories from each other, or do not record enough detail to reliably establish a relationship between the fault code and the repair. Repair costs and labor hours are also commonly not recorded or unavailable. Moreover, a lack of information about consequent business expenses due to break down can complicate the rational assignment of priorities.

The determined priorities are used to schedule vehicle maintenance. In some embodiments, the priorities are used simply to determine an order in which vehicles exhibiting certain fault codes are to be serviced. In other embodiments, the service provided to the vehicles can be modified based on the deemed criticality of the fault codes reported.

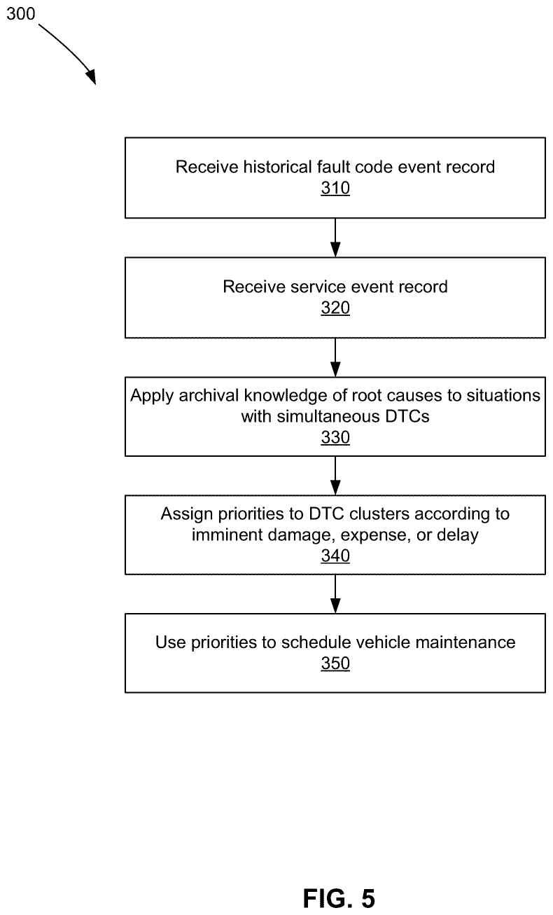

In order to adapt the method to such situations, a modification can be made which is less dependent on a high quality service record. FIG. 5 shows a modified method 300 for scheduling vehicle maintenance. In the method 300, the historical fault code event record is received (310). The service event record is received (320). Archival knowledge of root causes of situations with simultaneous DTCs is applied (330). Priorities are assigned to DTC clusters according to imminent damage, expense or delay (340). The determined priorities are then used to schedule vehicle maintenance (350).

This method 300 uses the observation that a combination of active fault codes can be more informative about the root cause of a problem than the incidence or frequency of individual fault codes. In this case, data may not be available to confirm the correctness of a relationship between service records and fault codes. However, the simultaneous activity of two or more fault codes provides more certainty about the root cause.

To help guide the end user, fault codes are assigned numerical priorities based on the vehicle system they are associated with. Fault codes associated with a root cause that might indicate an upcoming breakdown are assigned a higher priority, while fault codes which signal conditions that can be corrected with cleaning or adjustment or adding consumables are rated lower.

Such priorities are helpful, but there are other ways to think about presentation of fault code occurrences.

For example, some fault codes might occur often in different vehicles, or re-occur often in the same vehicle and rarely lead to breakdowns. The descriptions of these fault codes might be hard to understand, so the end user might not even know which vehicle system is involved, or what the potential financial costs of neglect might be. Such situations can result in unnecessary shop visits, and are a distraction for fleet operators.

This is the motivation for trying to leverage information that can come from looking at cases where two or more fault codes occur together (cluster). This analysis could add to the priority system by more accurately pinpointing significant issues. With a better idea of what is wrong, a manager could better decide which vehicle to send to the shop, and to be more comfortable when he or she decides not to send a vehicle to the shop.

In addition to warning about upcoming breakdowns, the approach disclosed herein helps fleet managers focus on important issues rather than unimportant ones.

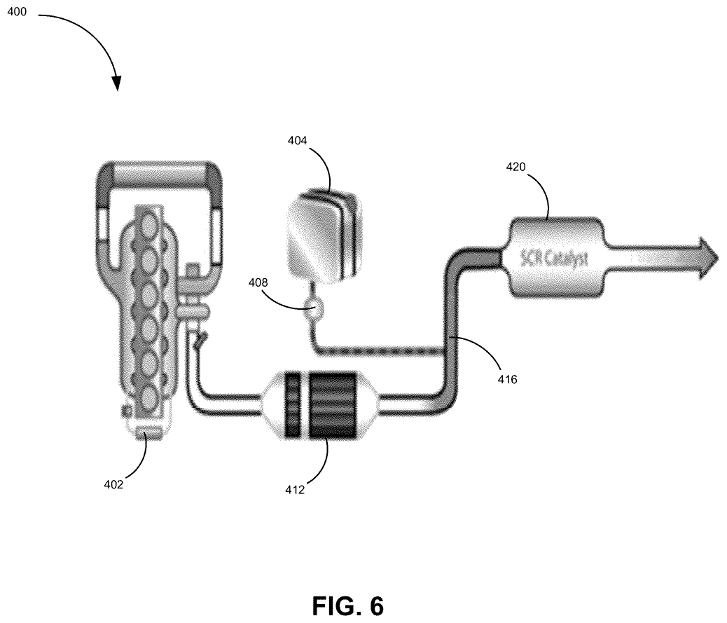

FIG. 6 shows various components of diesel exhaust system 400, including a diesel engine 40, a DEF tank 404, a dosing control unit 408, a diesel particulate filter 412, a decomposition reactor 416, and a SCR catalyst 420.

Fault codes related to the components of exhaust systems are the most common. A first approach to analyzing the fault codes is to detect if a group of fault codes refers to the same part of the vehicle. By matching fault codes to physical components in the exhaust system, it is possible to flag situations when more than one fault code points to the same physical component. This presumably means that the issue(s) to be signaled are related to a single root cause involving that component.

A second way to look at fault code groups is to determine which fault codes have occurred in the same vehicle over a limited period of time, say six months to a year. The results of such an analysis might overlap with the location mapping method suggested above, or it might group together functionally related components—for example components which are upstream or downstream from one another. In either case, a statistical association between fault codes can also point to a root cause, such as impurities in the DEF tank. See Table 5.

TABLE 5
Common exhaust fault codes

| CODE | DESCRIPTION | GROUP |
|---|---|---|
| 1072 | Catalyst system efficiency below threshold bank 2 | A |
| 3556 | Aftertreatment 1 hydrocarbon doser 1 | A |
| P20EE | SCR NOx catalyst efficiency below threshold bank | A |
| 3821 | Engine exhaust gas recirculation 1 valve 2 control | B |
| 2791 | Engine exhaust gas recirculation 1 valve 1 control | B |
| 5835 | Aftertreatment 1 particulate sensor (mg/m³) | C |
| P24D1 | Particulate matter sensor regeneration | C |
| P24AF | Particulate matter sensor circuit | C |
| 8430 | SCR NOx catalyst efficiency below threshold bank | D |
| P2698 | Exhaust aftertreatment fuel injector “A” | D |
| P05EB | Cold start SCR NOx catalyst inlet temperature too | D |
| 2791 | Engine exhaust gas recirculation 1 valve 1 control | E |
| 3821 | Engine exhaust gas recirculation 1 valve 2 control | E |
| 3251 | Aftertreatment 1 diesel particulate filter differential | F |
| 3216 | Engine exhaust 1 NOx 1 | F |

A cluster analysis identifies separate groups of vehicles with a certain pattern of fault code occurrence. Since there are many potential fault codes that can occur, it is a high dimensional space. If a vehicle is in one cluster and definitely excluded from another, it is good evidence of a different root cause.

When clusters are displayed, vehicles are labelled with 1-N according to which cluster they belong to. This is more useful for the analyst than the end user.

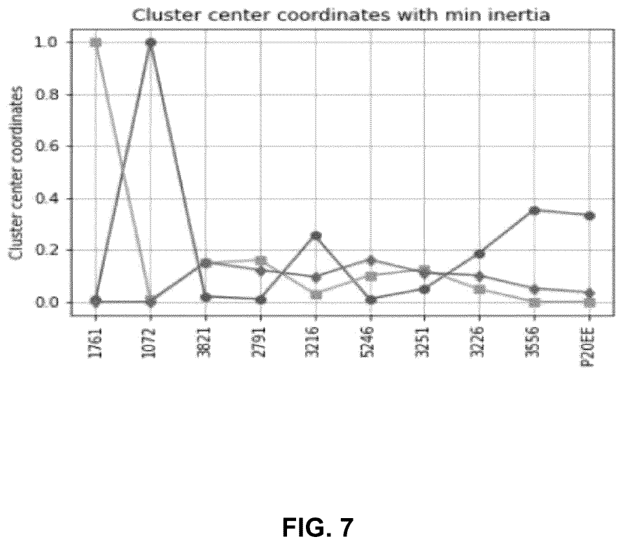

It is also possible to display a graph of the counts for the common fault codes in the cluster, such as the graph presented in FIG. 7. In this example of cluster centers, the first two clusters have a dominant fault code (1761, 1072), which increases the likelihood of several other less dominant fault codes. If several fault codes from the cluster in the same vehicle including the dominant one are seen, the probability that this is a real problem with an identifiable cause is increased.

When there is a dominant fault code in a cluster and it is accompanied by others in a cluster, it may be possible to tell an end user that the vehicle has a common set of symptoms that point to a real cause. One way to say this would be to say the vehicle emissions system is signaling a ‘stress pattern’ or ‘stress mode’ and that a ‘stress mode’ can lead eventually to a ‘failure mode’.

In terms of feature design, this can be reported separately from the individual fault codes.

Tables 5 to 8 show code counts and mean expected time to service (mETTS) in the CEL and NO CEL vehicle subsets. These values are combined for each Fault code to get the ranking in Tables 7 and 8 in the text.

TABLE 5
Fault codes incidence in the CEL vehicle set

| | Vehicle | Mean time to |
|---|---|---|
| Code | count | service (days) |
| P0420 | 1 | 0 |
| P0457 | 1 | 2 |
| P0353 | 1 | 2 |
| P0455 | 1 | 0 |
| P06B6 | 1 | 13 |
| U0108 | 1 | 11 |
| P0191 | 1 | 4 |
| P0305 | 1 | 35 |
| P0124 | 1 | 8 |
| P0300 | 3 | 5 |
| P0401 | 1 | 46 |
| P0456 | 1 | 32 |
| P0304 | 1 | 40 |

TABLE 6
SPN codes incidence in the CEL vehicle set

| | Vehicle | Mean time to |
|---|---|---|
| Code | count | service (days) |
| 91 | 1 | 9 |
| 8289 | 1 | 23 |
| 3359 | 2 | 19 |
| 524286 | 1 | 3 |
| 1390 | 1 | 44 |
| 810 | 1 | 29 |
| 627 | 1 | 40 |
| 1327 | 1 | 17 |
| 1180 | 1 | 3 |
| 411 | 1 | 7 |
| 111 | 1 | 2 |
| 2003 | 1 | 55 |
| 84 | 1 | 30 |
| 2659 | 3 | 2 |
| 1322 | 5 | 27 |
| 168 | 1 | 4 |

TABLE 7
Fault codes incidence in the NO CEL vehicle set

| | Vehicle | Mean time to |
|---|---|---|
| Code | count | service (days) |
| P0420 | 8 | 66 |
| P0457 | 1 | 101 |
| P0353 | 0 | NA |
| P0455 | 1 | 101 |
| P06B6 | 0 | NA |
| U0108 | 4 | 15 |
| P0191 | 0 | NA |
| P0305 | 6 | 77 |
| P0124 | 0 | NA |
| P0300 | 26 | 65 |
| P0401 | 0 | NA |
| P0456 | 2 | 46 |
| P0304 | 7 | 52 |

TABLE 9
SPN codes incidence in the NO_CEL vehicle set

| | Vehicle | Mean time |
|---|---|---|
| Code | count | to service |
| 91 | 15 | 62 |
| 8289 | 18 | 78 |
| 3359 | 10 | 73 |
| 524286 | 9 | 63 |
| 1390 | 5 | 72 |
| 810 | 17 | 54 |
| 627 | 41 | 60 |
| 1327 | 12 | 52 |
| 1180 | 0 | NA |
| 411 | 4 | 74 |
| 111 | 13 | 51 |
| 2003 | 17 | 59 |
| 84 | 8 | 58 |
| 2659 | 2 | 72 |
| 1322 | 37 | 53 |
| 168 | 13 | 49 |

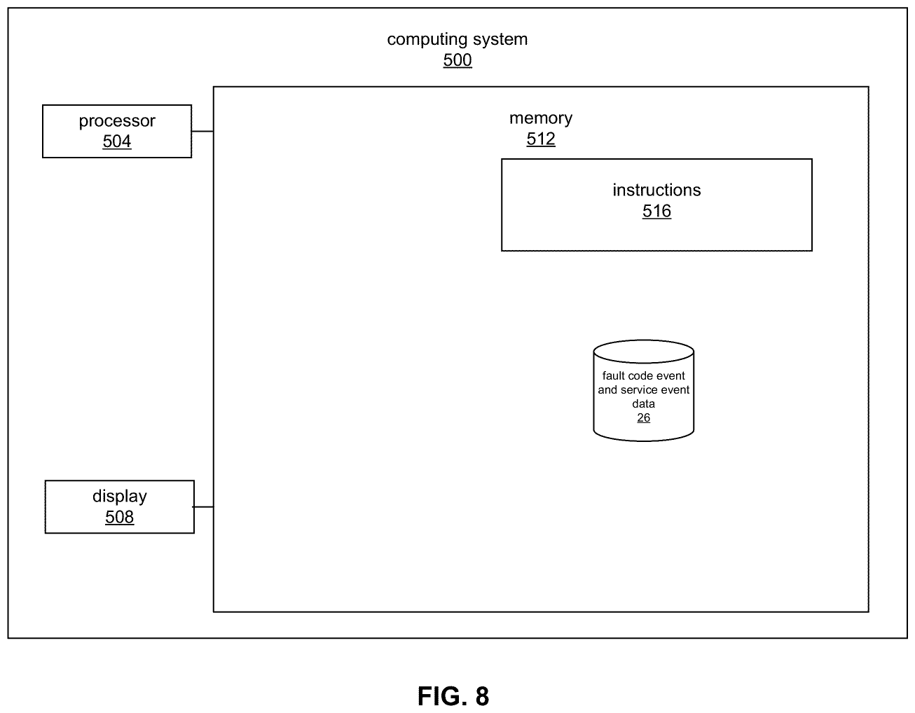

FIG. 8 shows various physical and logical components of an exemplary computing system 500 for scheduling vehicle maintenance in accordance with an embodiment of the present disclosure. Although an example embodiment of the computing system 500 is shown and discussed below, other embodiments may be used to implement examples disclosed herein, which may include components different from those shown. Although FIG. 8 shows a single instance of each component of the computing system 500, there may be multiple instances of each component shown.

The computing system 500 includes one or more processors 504, such as a central processing unit, a microprocessor, an application-specific integrated circuit (ASIC), a field-programmable gate array (FPGA), a dedicated logic circuitry, a tensor processing unit, a neural processing unit, a dedicated artificial intelligence processing unit, or combinations thereof. The one or more processors 504 may collectively be referred to as a processor 504. The computing system 500 may include a display 508 for outputting data and/or information in some applications, but may not in some other applications.

The computing system 500 includes one or more memories 512 (collectively referred to as “memory 512”), which may include a volatile or non-volatile memory (e.g., a flash memory, a random access memory (RAM), and/or a read-only memory (ROM)). The non-transitory memory 512 may store machine-executable instructions for execution by the processor 504. A set of machine-executable instructions 516 defining a system for scheduling vehicle maintenance (described herein) is shown stored in the memory 512, which may be executed by the processor 504 to perform the steps of the methods for scheduling vehicle maintenance described herein. The memory 512 may include other machine-executable instructions for execution by the processor 504, such as machine-executable instructions for implementing an operating system and other applications or functions.

In addition, the memory 512 stores or caches data for the fault code event record and the service event record in the database 26. This data can be stored permanently or retrieved in part or in whole as required from other systems.

In some examples, the computing system 500 may also include one or more electronic storage units (not shown), such as a solid state drive, a hard disk drive, a magnetic disk drive and/or an optical disk drive. In some examples, one or more datasets and/or modules may be provided by an external memory (e.g., an external drive in wired or wireless communication with the computing system 500) or may be provided by a transitory or non-transitory computer-readable medium. Examples of non-transitory computer readable media include a RAM, a ROM, an erasable programmable ROM (EPROM), an electrically erasable programmable ROM (EEPROM), a flash memory, a CD-ROM, or other portable memory storage. The storage units and/or external memory may be used in conjunction with memory 512 to implement data storage, retrieval, and caching functions of the computing system 500.

The components of the computing system 500 may communicate with each other via a bus, for example. In some embodiments, the computing system 500 is a distributed computing system and may include multiple computing devices in communication with each other over a network, as well as optionally one or more additional components. The various operations described herein may be performed by different computing devices of a distributed system in some embodiments. In some embodiments, the computing system 500 is a virtual machine provided by a cloud computing platform.

Although the components for both training and using the audio-visual transformation network 20 are shown as part of the computing system 500, it will be understood that separate computing devices can be used for training and using the audio-visual transformation network 20 for generating visual images from audio data.

The steps (also referred to as operations) in the flowcharts and drawings described herein are for purposes of example only. There may be many variations to these steps/operations without departing from the teachings of the present disclosure. For instance, the steps may be performed in a differing order, or steps may be added, deleted, or modified, as appropriate.

### General

Through the descriptions of the preceding embodiments, the present invention may be implemented by using hardware only, or by using software and a necessary universal hardware platform, or by a combination of hardware and software. The coding of software for carrying out the above-described methods described is within the scope of a person of ordinary skill in the art having regard to the present disclosure. Based on such understandings, the technical solution of the present invention may be embodied in the form of a software product. The software product may be stored in a non-volatile or non-transitory storage medium, which can be an optical storage medium, flash drive or hard disk. The software product includes a number of instructions that enable a computing device (personal computer, server, or network device) to execute the methods provided in the embodiments of the present disclosure.

All values and sub-ranges within disclosed ranges are also disclosed. Also, although the systems, devices and processes disclosed and shown herein may comprise a specific plurality of elements, the systems, devices and assemblies may be modified to comprise additional or fewer of such elements. Although several example embodiments are described herein, modifications, adaptations, and other implementations are possible. For example, substitutions, additions, or modifications may be made to the elements illustrated in the drawings, and the example methods described herein may be modified by substituting, reordering, or adding steps to the disclosed methods.

Features from one or more of the above-described embodiments may be selected to create alternate embodiments comprised of a sub-combination of features which may not be explicitly described above. In addition, features from one or more of the above-described embodiments may be selected and combined to create alternate embodiments comprised of a combination of features which may not be explicitly described above. Features suitable for such combinations and sub-combinations would be readily apparent to persons skilled in the art upon review of the present disclosure as a whole.

In addition, numerous specific details are set forth to provide a thorough understanding of the example embodiments described herein. It will, however, be understood by those of ordinary skill in the art that the example embodiments described herein may be practiced without these specific details. Furthermore, well-known methods, procedures, and elements have not been described in detail so as not to obscure the example embodiments described herein. The subject matter described herein and in the recited claims intends to cover and embrace all suitable changes in technology.

Although the present invention and its advantages have been described in detail, it should be understood that various changes, substitutions and alterations can be made herein without departing from the invention as defined by the appended claims.

The present invention may be embodied in other specific forms without departing from the subject matter of the claims. The described example embodiments are to be considered in all respects as being only illustrative and not restrictive. The present disclosure intends to cover and embrace all suitable changes in technology. The scope of the present disclosure is, therefore, described by the appended claims rather than by the foregoing description. The scope of the claims should not be limited by the embodiments set forth in the examples, but should be given the broadest interpretation consistent with the description as a whole.

1. A computer-implemented method for scheduling vehicle maintenance, comprising:
receiving a fault code history and a service event history for a set of vehicles, the fault code history including fault code events for each of a set of fault codes, the service event history including service events for each of a set of service event types;
correlating subsets of the set of fault codes with subsets of the service events at least partially based on the fault code history and the service event history;
assigning a service priority rating to each fault code of the set of fault codes at least partially based on the correlated subset or subsets of the service events, the fault code history, and the service event history; and
scheduling a vehicle maintenance event for a vehicle based on the service priority rating for each fault code event for the vehicle.

2. The computer-implemented method of claim 1, wherein the subsets of the set of fault codes include two or more fault codes of the set of fault codes.

3. The computer-implemented method of claim 1, further comprising:
estimating at least one of service availability and part availability for at least one of the set of the service event types, and
wherein the assigning of the service priority rating is at least partially based on the at least one of the estimated service availability and the estimated part availability for the at least one of the set for the service type events.

4. The computer-implemented method of claim 1, wherein the fault code history is a first fault code history for a first set of vehicles of a first vehicle type, the service event history is a first service event history for the first set of vehicles, the service priority rating is a first service priority rating, the method further comprising:
receiving a second fault code history and a second service event history for a second set of vehicles, the second fault code history including fault code events for each of the set of fault codes, the second service event history including service events for each of a set of service event types;
correlating subsets of the set of fault codes with subsets of the service events at least partially based on the second fault code history and the second service event history; and
assigning a second service priority rating to each fault code of the set of fault codes at least partially based on the correlated subset or subsets of the service events, the second fault code history, and the second service event history,
wherein the revising includes revising the vehicle maintenance event schedule for the vehicle based on:
if the vehicle is of the first vehicle type, the first service priority rating for each fault code event for the vehicle; or
if the vehicle is of the second vehicle type, based on the second service priority rating for each fault code event for the vehicle.

5. The computer-implemented method of claim 1, wherein the correlating includes determining a mean time to failure for each subset of fault codes.

6. The computer-implemented method of claim 1, wherein the correlating includes determining a mean time to failure for each fault code of the set of fault codes.

7. The computer-implemented method of claim 1, wherein the service priority rating is at least partially based on at least one of:
downtime cost; and
an estimated time to failure.

8. The computer-implemented method of claim 1, wherein the assigning includes, for each of the set of fault codes, a total number of positive cases where fault code events led to service events and a total number of negative cases where an absence of fault code events led to an absence of service events.

9. The computer-implemented method of claim 1, wherein the correlating is performed using a machine learning model.

10. A computing system for scheduling vehicle maintenance, comprising:
one or more processors; and
a memory storing machine-executable instructions that, when executed by the one or more processors, cause the computing system to:
receive a fault code history and a service event history for a set of vehicles, the fault code history including fault code events for each of a set of fault codes, the service event history including service events for each of a set of service event types;
correlate subsets of the set of fault codes with subsets of the service events at least partially based on the fault code history and the service event history;
assign a service priority rating to each fault code of the set of fault codes at least partially based on the correlated subset or subsets of the service events, the fault code history, and the service event history; and
schedule a vehicle maintenance event for a vehicle based on the service priority rating for each fault code event for the vehicle.

11. The computing system of claim 10, wherein the subsets of the set of fault codes include two or more fault codes of the set of fault codes.

12. The computing system of claim 10, wherein the machine-executable instructions, when executed by the one or more processors, cause the computing system to:
estimate at least one of service availability and part availability for at least some of the set of the service event types, and
assign the service priority rating at least partially based on the at least one of the estimated service availability and the estimated part availability for the at least some of the set for the service type events.

13. The computing system of claim 10, wherein the fault code history is a first fault code history for a first set of vehicles of a first vehicle type, the service event history is a first service event history for the first set of vehicles, the service priority rating is a first service priority rating, and wherein the machine-executable instructions, when executed by the one or more processors, cause the computing system to:
receive a second fault code history and a second service event history for a second set of vehicles, the second fault code history including fault code events for each of the set of fault codes, the second service event history including service events for each of a set of service event types;
correlate subsets of the set of fault codes with subsets of the service events at least partially based on the second fault code history and the second service event history;
assign a second service priority rating to each fault code of the set of fault codes at least partially based on the correlated subset or subsets of the service events, the second fault code history, and the second service event history; and
revise the vehicle maintenance event schedule for the vehicle based on the first service priority rating for each fault code event for the vehicle if the vehicle is of the first vehicle type, or based on the second service priority rating for each fault code event for the vehicle if the vehicle is of the second vehicle type.

14. The computing system of claim 10, wherein the machine-executable instructions, when executed by the one or more processors, cause the computing system to determine a mean time to failure for each subset of fault codes.

15. The computing system of claim 10, wherein the machine-executable instructions, when executed by the one or more processors, cause the computing system to determine a mean time to failure for each fault code of the set of fault codes.

16. The computing system of claim 10, wherein the machine-executable instructions, when executed by the one or more processors, cause the computing system to determine the service priority rating at least partially based on downtime cost.

17. The computing system of claim 10, wherein the service priority rating is at least partially based on an estimated time to failure.

18. The computing system of claim 10, wherein the machine-executable instructions, when executed by the one or more processors, cause the computing system to assign, for each of the set of fault codes, a total number of positive cases where fault code events led to service events and a total number of negative cases where an absence of fault code events led to an absence of service events.

19. The computing system of claim 10, wherein the machine-executable instructions, when executed by the one or more processors, cause the computing system to correlate the subsets of the set of fault codes with subsets of the service events using a machine learning model.

20. A non-transitory machine-readable medium having tangibly stored thereon executable instructions for execution by one or more processors, wherein the executable instructions, in response to execution by the one or more processors, cause the one or more processors to perform the method of claim 1.
